(19) United States
(12) Patent Application Publication
(10) Pub. No.: US 2007/0022272 A1
(43) Pub. Date: Jan. 25, 2007

(54) Microprocessor

(75) Inventor: Isao Katayama, Kanagawa (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Minato-ku (JP)

(21) Appl. No.: 11/274,401

(22) Filed: Nov. 16, 2005

(30) Foreign Application Priority Data
Jul. 21, 2005 (JP) 2005-211921

(51) Int. Cl. G06F 9/30

(52) U.S. Cl. 712/214

(57) ABSTRACT

The present invention includes a pipeline having a plurality of stages, and a resource management unit configured to be connected to the pipeline and manage circuit resources for processing instructions. An instruction fetch unit is configured to issue processing commands to the pipeline, receive a busy signal BS from the resource management unit requesting the fetch unit to stop issuing commands to the pipeline, and then stops issuing commands to the pipeline. An instruction selector is configured to receive a processing command from the instruction fetch unit and a command from a final stage of the pipeline to re-enter the pipeline, via a re-entry path extending to a first stage of the pipeline, and select an instruction to enter the pipeline in conformity with a control signal SCS from the resource management unit.

### CROSS REFERENCE TO RELATED APPLICATIONS AND INCORPORATION BY REFERENCE

This application is based upon and claims the benefit of priority from prior Japanese Patent Application P2005-211921 filed on Jul. 21, 2005; the entire contents of which are incorporated by reference herein.

### BACKGROUND OF THE INVENTION

1. Field of the Invention

The present invention relates to a microprocessor. More specifically, it relates to a microprocessor having both high-speed operability and high functionality.

2. Description of the Related Art

In recent years, only instructions that can be executed by a small and simple circuit have been implemented in microprocessors. Further, program execution duration has been shortened by dividing processing into multiple stages independent from one another and then carrying out those stages in parallel. Calculation instructions, load/store instructions or related instructions can be relatively easily implemented in such a manner. However, execution of some of control instructions for a microprocessor requires the entire operation of the microprocessor to halt, bringing about complex processing and difficulty in dividing and assigning processing to pipeline stages.

Conventionally, to implement such an instruction, a large circuit and complex controls have been provided, either dividing and assigning processing to pipeline stages, or dividing and separating processing from the pipeline. When dividing and assigning processing to pipeline stages, problems of an increase in power consumption and/or incorporation of defective circuits, due to circuit complexity, may develop. On the other hand, when dividing and separating processing from the pipeline, performance of the microprocessor deteriorates due to insufficient correlation between instructions.

Moreover, according to conventional microprocessors, when determining whether or not execution of an instruction in the pipeline is possible in the present status of the pipeline or the entire microprocessor status, the operation in that stage needs to be the same as that in the stage in which the determination has started, so as to obtain the determination results. This is because, if it is determined that execution is impossible, the operation in that stage should be frozen until the instruction becomes executable and execution is restarted.

According to such an implementation method, when the time between beginning of the stage to determine whether or not the instruction is executable and a time at which the determination results are provided becomes longer than that for execution in other stages. The processing time for a circuit for determining whether or not an instruction is executable specifies an operating frequency for the entire microprocessor.

In recent years, demand for integrating multiple microprocessors into a single chip has increased, and accordingly, the circuit for determining whether or not an instruction is executable tends to be more complex and operate at a lower speed, which is a problem.

An instruction issuing device and an instruction issuing method, particularly using an instruction scheduling unit of a microprocessor that issues instructions out of order, are disclosed in Japanese Patent Gazette No. 3577052, the date of issuing is Oct. 13, 2004. More specifically, an instruction issuing device and an instruction issuing method is disclosed that is capable of quickly detecting an instruction having a multistage dependency on a load instruction when a cache miss occurs in the load instruction.

### SUMMARY OF THE INVENTION

An aspect of the present invention inheres in a microprocessor having a pipeline including a plurality of stages. The microprocessor includes a resource management unit configured to be connected to the pipeline and manage circuit resources for processing; an instruction fetch unit configured to issue processing commands to the pipeline, receive from the resource management unit a busy signal for requesting the stopping of issuing commands to the pipeline, and stop issuing commands to the pipeline; and an instruction selector configured to receive the processing command from the instruction fetch unit and a command from a final stage of the pipeline that will re-enter the pipeline itself via a re-entry path extending to a first stage of the pipeline, and select an instruction to enter the pipeline in conformity with a control signal from the resource management unit.

Another aspect of the present invention inheres in a microprocessor which includes a pipeline having a plurality of stages. The microprocessor further includes a resource management unit configured to be connected to the pipeline and manage circuit resources for processing; an instruction fetch unit configured to issue processing commands to the pipeline, receive from the resource management unit a busy signal requesting stoppage of issuing commands to the pipeline, and stop issuing commands to the pipeline; and an instruction selector configured to receive a processing command from the instruction fetch unit and a command from a final stage of the pipeline that will re-enter the pipeline itself via a re-entry path extending to a first stage of the pipeline, and select an instruction to enter the pipeline in conformity with a control signal from the resource management unit. The plurality of stages includes respective pipeline registers storing re-execution flags. The resource management unit returns results of the requests to determine whether or not an instruction received from the first stage in a stage several cycles later is expectable, and stores the re-execution flags in the respective pipeline registers for all stages upstream from a stage in which an instruction has been requested to determine whether or not the instruction is executable.

### BRIEF DESCRIPTION OF DRAWINGS

FIG. 1 is a schematic block diagram of a processing unit of a microprocessor according to a first embodiment of the present invention;

FIG. 2 is a schematic block diagram of a stage management queue in a pipeline stage controller of the microprocessor according to the first embodiment of the present invention;

FIG. 3A schematically shows characteristics of circuit resources, which implement RISC processor instructions, and an exemplary processing queue during processing of a RISC instruction 18;

FIG. 3B schematically shows characteristics of circuit resources, which implement RISC processor instructions, and conceptually shows circuit regions in a microprocessor chip for processing respective stages;

FIG. 4A schematically shows characteristics of circuit resources, which implement CISC processor instructions, and the processing queue during processing of a CISC instruction 20;

FIG. 4B schematically shows characteristics of circuit resources, which implement CISC processor instructions, and conceptually shows a circuit region in the microprocessor chip for processing respective stages;

FIG. 5 shows progression of processing through pipeline stages when a RISC processor instruction has entered the pipeline of the microprocessor according to the first embodiment of the present invention;

FIG. 6 shows progression of processing through pipeline stages when a RISC processor instruction has entered the pipeline of the microprocessor according to the first embodiment of the present invention;

FIG. 7 shows progression of processing through pipeline stages when a RISC processor instruction has entered the pipeline of the microprocessor according to the first embodiment of the present invention;

FIG. 8 shows progression of processing through pipeline stages when a RISC processor instruction has entered the pipeline of the microprocessor according to the first embodiment of the present invention;

FIG. 9 shows progression of processing through pipeline stages when a RISC processor instruction has entered the pipeline of the microprocessor according to the first embodiment of the present invention;

FIG. 10 shows progression of processing through pipeline stages when a CISC processor instruction has entered the pipeline of the microprocessor according to the first embodiment of the present invention;

FIG. 11 shows progression of processing through pipeline stages when a CISC processor instruction has entered the pipeline of the microprocessor according to the first embodiment of the present invention;

FIG. 12 shows progression of processing through pipeline stages when a CISC processor instruction has entered the pipeline of the microprocessor according to the first embodiment of the present invention;

FIG. 13 shows progression of processing through pipeline stages when a CISC processor instruction has entered the pipeline of the microprocessor according to the first embodiment of the present invention;

FIG. 14 shows progression of processing through pipeline stages when a CISC processor instruction has entered the pipeline of the microprocessor according to the first embodiment of the present invention;

FIG. 15 shows progression of processing through pipeline stages when a CISC processor instruction has entered the pipeline of the microprocessor according to the first embodiment of the present invention;

FIG. 16 shows progression of processing through pipeline stages when a CISC processor instruction has entered the pipeline of the microprocessor according to the first embodiment of the present invention;

FIG. 17 shows progression of processing through pipeline stages when a CISC processor instruction has entered the pipeline of the microprocessor according to the first embodiment of the present invention;

FIG. 18 shows progression of processing through pipeline stages when a CISC processor instruction has entered the pipeline of the microprocessor according to the first embodiment of the present invention;

FIG. 19 is a schematic block diagram of a processing unit of a microprocessor according to a second embodiment of the present invention;

FIG. 20 shows progression of processing through pipeline stages when a RISC processor instruction has entered the pipeline of the microprocessor according to the second embodiment of the present invention;

FIG. 21 shows progression of processing through pipeline stages when a RISC processor instruction has entered the pipeline of the microprocessor according to the second embodiment of the present invention;

FIG. 22 shows progression of processing through pipeline stages when a RISC processor instruction has entered the pipeline of the microprocessor according to the second embodiment of the present invention;

FIG. 23 shows progression of processing through pipeline stages when a RISC processor instruction has entered the pipeline of the microprocessor according to the second embodiment of the present invention;

FIG. 24 shows progression of processing through pipeline stages when a RISC processor instruction has entered the pipeline of the microprocessor according to the second embodiment of the present invention;

FIG. 25 shows progression of processing through pipeline stages when a RISC processor instruction has entered the pipeline of the microprocessor according to the second embodiment of the present invention;

FIG. 26 shows progression of processing through pipeline stages when a RISC processor instruction has entered the pipeline of the microprocessor according to the second embodiment of the present invention;

FIG. 27 shows progression of processing through pipeline stages when a RISC processor instruction has entered the pipeline of the microprocessor according to the second embodiment of the present invention;

FIG. 28 shows progression of processing through pipeline stages when a RISC processor instruction has entered the pipeline of the microprocessor according to the second embodiment of the present invention;

FIG. 29 shows progression of processing through pipeline stages when a RISC processor instruction has entered the pipeline of the microprocessor according to the second embodiment of the present invention; and

FIG. 30 shows progression of processing through pipeline stages when a RISC processor instruction has entered the pipeline of the microprocessor according to the second embodiment of the present invention.

### DETAILED DESCRIPTION OF THE INVENTION

Various embodiments of the present invention will be described with reference to the accompanying drawings. It is to be noted that the same or similar reference numerals are applied to the same or similar parts and elements throughout the drawings, and the description of the same or similar parts and elements will be omitted or simplified.

Referring to the drawings, embodiments of the present invention are described below. The embodiments shown below exemplify an apparatus and a method that are used to implement the technical ideas according to the present invention, and do not limit the technical ideas according to the present invention to those that appear below. These technical ideas, according to the present invention, may receive a variety of modifications that fall within the claims.

Next, a first and a second embodiment of the present invention is described while referencing drawings. The same or similar reference numerals are attached to the same or similar parts in the following drawing description. Note that those drawings are merely schematics and thus relationship between thickness of respective parts and two-dimensional size thereof may be inconsistent with reality according to the present invention.

The first through the second embodiment as described below exemplify apparatus or systems, which embody technical ideas according to the present invention. Therefore, the technical ideas according to the present invention do not limit shapes, structures, arrangements or the like of parts to those described below. The technical ideas according to the present invention may be modified into a variety of modifications within the scope of the claimed invention.

With a microprocessor having a processing pipeline divided into multiple stages, the addition of a mechanism that requests the stoppage of issuing commands to the processing pipeline, flags for invalidating execution of an instruction within the pipeline, and a mechanisms for providing an instruction re-entry path and making a command in the last stage of the pipeline re-enter the first stage for the pipeline, via that path, incorporates multi-functional instructions such as CISC processor instructions with a RISC processor instruction system using a small number of additional circuits (e.g., an instruction re-entry path and/or an instruction selector). Cost control of the microprocessor is achieved by reduction of memory capacity, due to improving in instruction density and low power consumption.

By controlling the pipeline during the RISC processor, before being able to determine whether a certain instruction is executable, execution of a next instruction may be executed speculatively, allowing the microprocessor to operate at a higher speed.

The addition of a small circuit to the RISC processor, capable of parallel execution but only implementing simple instructions makes it possible to implement instructions that are not affected by the structure of the pipeline stages in the RISC processor. This procedure increases the scale of processor instructions, improves instruction execution efficiency, and reduces power consumption and costs of the microprocessor.

Use of a re-execution flags and the instruction re-enter function does not allow an upstream stage to receive results of whether or not an instruction in the same upstream stage of the instruction processing pipeline is executable. Rather, a downstream stage of that pipeline receives instead, during execution of instructions by the microprocessor. This procedure prevents a decrease in processing speed of the microprocessor, even if a complicated determination of whether or not an instruction is executable is made.

According to the microprocessor of the present invention, complex instruction set computer (CISC) processor instructions may be easily executed by a reduced instruction set computer (RISC) processor instruction system. Moreover, the microprocessor may have both higher speed operability and increased functionality, which is provided by improving the RISC processor pipeline processing speed, and decreases costs by reducing memory capacity by the improved instruction density and decreasing power consumption.

[First Embodiment]

A microprocessor, according to the first embodiment of the present invention, easily implements CISC processor instructions in a RISC processor.

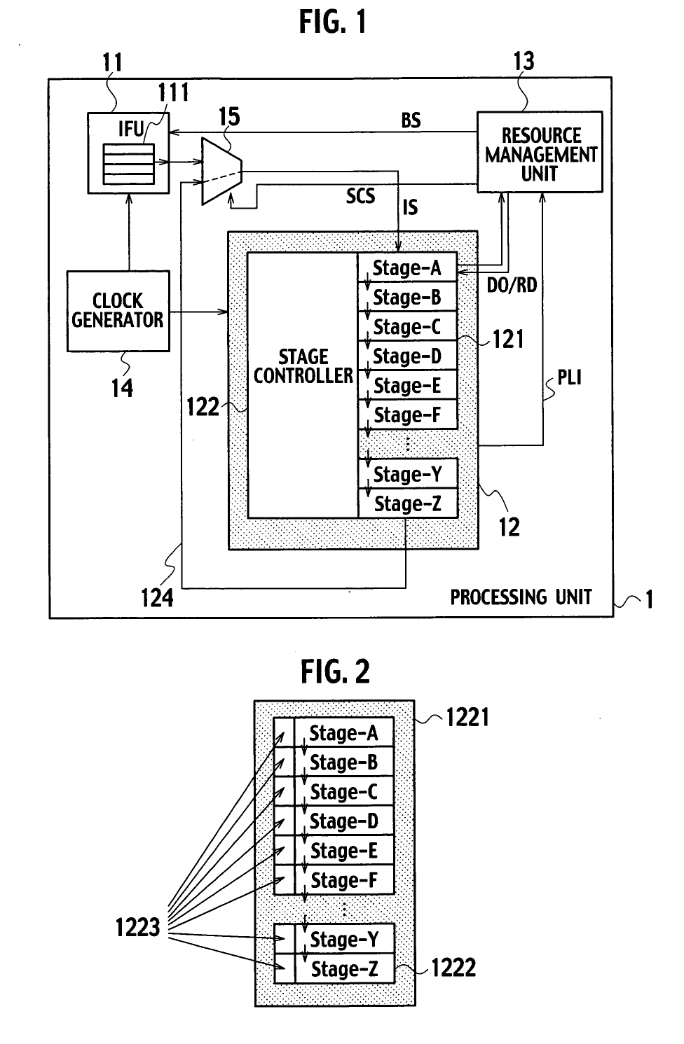

As shown in FIG. 1, in the microprocessor according to the first embodiment of the present invention, a processing unit 1 includes a pipeline 12 having multiple stages, a resource management unit (RMU) 13 connected to the pipeline 12. The RMU 13 manages circuit resources for processing. Also included is an instruction fetch unit (IFU) 11, which issues processing commands to the pipeline 12, receives a busy signal BS requests the stopping of issuance of commands to the pipeline 12 from the resource management unit 13, and stops issuing commands to the pipeline 12, a clock generator 14 connected to the instruction fetch unit 11 and the pipeline 12 to regulate operation timing, and an instruction selector 15, which receives a processing command from the instruction fetch unit 11 and a command to re-enter the pipeline 12 via a re-entry path (RedoLoop) 124 extending from the final Stage-Z to the first Stage-A of the pipeline 12. The instruction selector 15 also selects an instruction to enter the pipeline 12 in conformity with a control signal SCS from the resource management unit 13.

Alternatively, the pipeline 12 of the microprocessor may include a stage management queue 1221 for managing progress of processing through instruction stages for instructions that have been entered.

Further, the stage management queue 1221 of the microprocessor may include an instruction holding unit 1222 having various stages. Each of the stages retains an instruction code that will either require or not require re-execution of processing for the code, and a stage controller 122 storing re-execution flags (RDF) 1223.

Further, the instruction selector 15 of the microprocessor may receive, via the re-entry path 124, an instruction code in the final Stage-Z of the pipeline 12, which will either need or not need to be executed. Then, the instruction selector 15 makes that instruction code enter the first Stage-A of the pipeline 12.

Otherwise, the pipeline 12 of the microprocessor may execute CISC processor instructions, which would occupy the entire pipeline 12.

The instruction fetch unit 11 retains, in instruction memory 111, an instruction sequence to be entered in the processing unit 1, and then controls an instruction to enter the pipeline 12 in synch with a clock cycle.

The resource management unit 13 receives a pipeline information signal PLI from the pipeline 12 and then manages operating statuses of respective stages of the pipeline 12 and processing for instructions. Furthermore, the resource management unit 13 determines, from current stage statuses of the pipeline 12, whether an instruction that has entered the pipeline 12 is executable, and then returns a resulting DO/RD (Do/Re-do) signal to the pipeline 12. Moreover, if the determination of the resource management unit 13 says that it is impossible to enter the instruction, the busy signal BS is transmitted to request the instruction fetch unit 11 to stop an instruction from entering the pipeline.

The pipeline 12 is divided into stages 121 including Stage-A, Stage-B, . . . , to Stage-Z for processing the entered instructions. The stage-divided pipeline 12 conducts processing in a bucket brigade manner in sync with the clock generator 14 connected thereto. In other words, an instruction that has entered the first Stage-A, by the instruction fetch unit 11, progresses to the Stage-B in sync with the subsequent clock cycle, and then to a Stage-C in sync with a further subsequent clock cycle. Respective stages are controlled by the stage controller 122.

An instruction entry path along which an instruction signal IS is issued from the instruction selector 15 is provided in the first Stage-A. Furthermore, the pipeline 12 concludes processing for each instruction at the final Stage-Z; however, for the case where the processing is not completed at the final Stage-Z, the pipeline 12 includes the re-entry path 124, along which instructions re-enter the first Stage-A.

The instruction selector 15 selects either one of an instruction from the instruction fetch unit 11 or an instruction from the final Stage-Z, in conformity with a control signal from the resource management unit 13, and then commands the selected instruction enter the first Stage-A of the pipeline 12.

The pipeline 12 includes the stage management queue 1221 for managing processing progression through stages for entered instructions, as shown in FIG. 2. The stage management queue 1221 includes the instruction retaining unit 1222, which retains instruction codes for respective stages and the re-execution flags 1223.

The microprocessor, according to the first embodiment of the present invention, is assumed to execute, in order, RISC processor instructions and CISC processor instructions.
(i) RISC processor instructions provide a divided stages structure in a processing pipeline, independent from one another; and
(ii) CISC processor instructions that do not provide a divided stages structure in a processing pipeline, independent from one another.

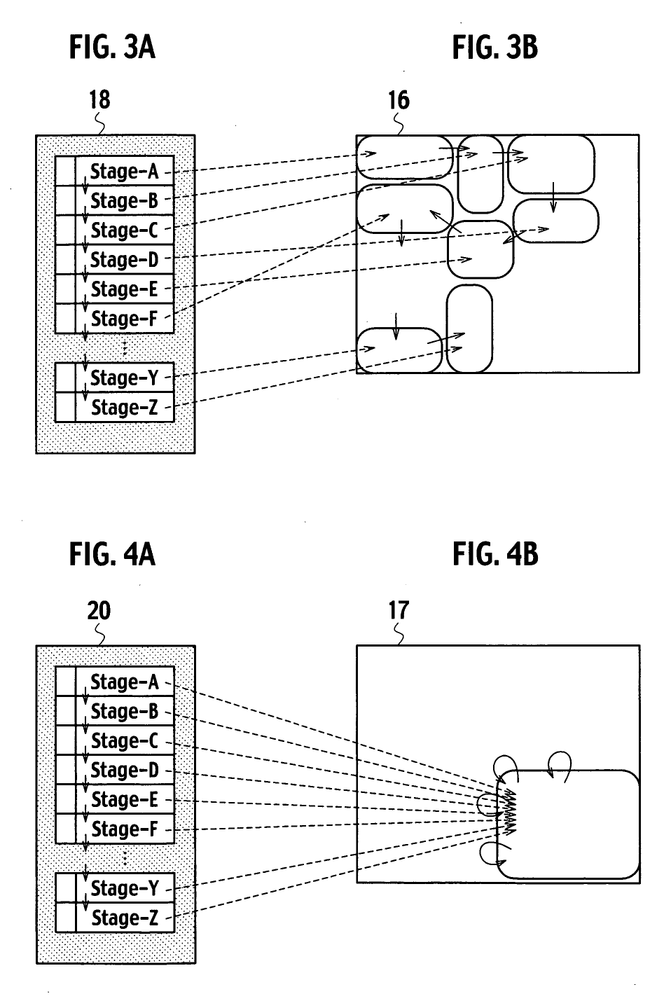

FIGS. 3 and 4 generally show that RISC processor instructions provide a divided stages structure in a processing pipeline, independent from one another, and in contrast, that CISC processor instructions do not provide a divided stages structure in a processing pipeline, independent from one another.

FIG. 3A schematically shows characteristics of circuit resources, which implement RISC processor instructions, and an exemplary processing queue during processing of a RISC instruction 18. FIG. 3B schematically shows characteristics of circuit resources, which implement RISC processor instructions, and conceptually shows circuit regions in a microprocessor chip for processing respective stages. Since there are no overlapped circuits for processing in respective stages, an instruction can enter the first stage in sync with each clock cycle as long as processing proceeds to the next stage in sync with each clock cycle. In other words, the same number of instructions as the number of stages in a single pipeline 12 can be executed in parallel.

FIG. 4A shows characteristics of circuit resources, schematically, which implement CISC processor instructions, and an exemplary processing queue during processing of a CISC instruction 20. FIG. 4B schematically shows characteristics of circuit resources, which implement CISC processor instructions, and conceptually shows a circuit region in a microprocessor chip for processing respective stages. Since circuit resources of the microprocessor processing a single instruction are not divided for respective stages, parallel processing is impossible, even if the instruction is divided into pipeline stages, and thus the instruction occupies the entire pipeline while processing.

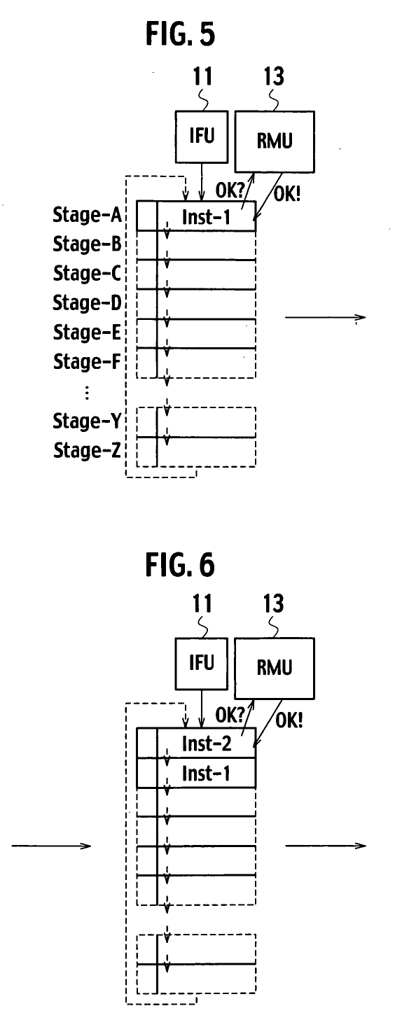

(A) Progression of processing through pipeline stages when RISC processor instructions having consecutively entered is illustrated in FIGS. 5 through 9.

(A-1) As shown in FIG. 5, when there is no instruction being executed in the pipeline, an instruction Inst-1 enters the Stage-A from the IFU 11. A request (OK?) for determination of whether or not to operate the execution of the Inst-1 in the stage A is issued to the RMU 13, and is determined to be executable (OK!) since there is no reason for disturbing execution of the Inst-1 in the stage A.

(A-2) As shown in FIG. 6, in the next clock cycle, an instruction Inst-2 enters the Stage-A from the IFU 11. A request (OK?) for determination of whether or not to operate the execution of the instruction Inst-2 is issued to the RMU 13, and the preceding instruction Inst-1 is determined to be executable (OK!) since there is no reason for disturbing execution of the instruction Inst-2.

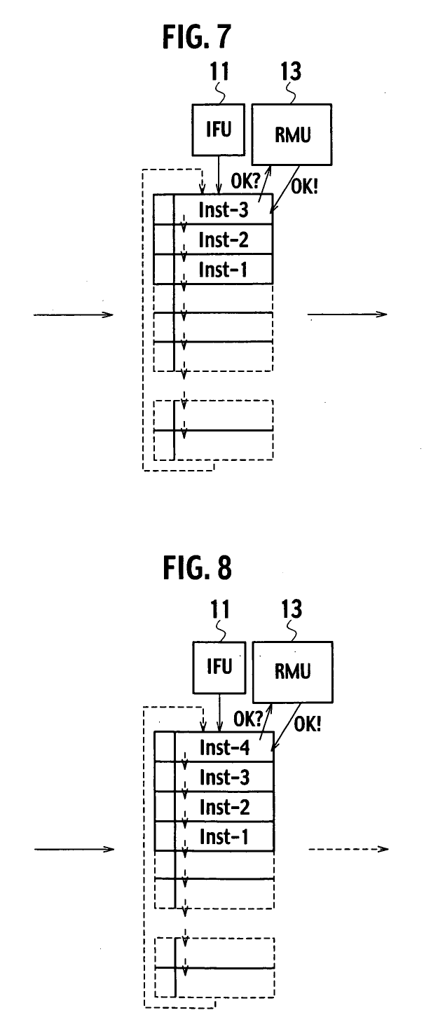

(A-3) As shown in FIG. 7, in the next clock cycle, an instruction Inst-3 enters the Stage-A from the IFU 11. A request (OK?) for determination of whether or not to operate the execution of the instruction Inst-3 is issued to the RMU 13, and the preceding instructions Inst-1 and Inst-2 are determined to be executable (OK!) since there is no reason for disturbing execution of the instruction Inst-3.

(A-4) As shown in FIG. 8, in the next clock cycle, an instruction Inst-4 enters the Stage-A from the IFU 11. A request (OK?) for determination of whether or not to operate the execution of the instruction Inst-4 is issued to the RMU 13, and the preceding instructions Inst-1, Inst-2, and Inst-3 are determined to be executable (OK!) since there is no cause for disturbing execution of the instruction Inst-4.

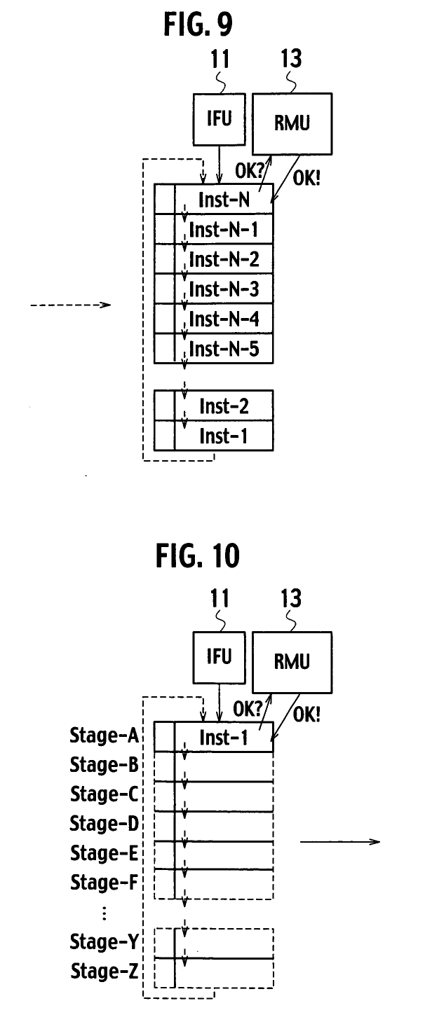

(A-N) As shown in FIG. 9, in the N-th clock cycle, an instruction Inst-N enters the Stage-A from the IFU 11. A request (OK?) for determination of whether or not to operate the execution of the instruction Inst-N is issued to the RMU 13, and the preceding instructions Inst-1, Inst-2, Inst-3, . . . , Inst-N-1 are determined to be executable (OK!) since there is no reason for disturbing execution of the instruction Inst-N.

As described above, in pipeline stages at the time when RISC processor instructions have consecutively entered the pipeline, instructions enter the Stage-A one after another from the IFU 11, and all the instructions are determined as executable. Since there are no overlapped circuits for processing in the stages, an instruction may enter the first stage in each clock cycle as long as processing proceeds to the next stage at each clock cycle. Thus, parallel execution of the same number of instructions as the number of stages in a single pipeline 12 is performed.

(B) Progression of processing through pipeline stages when CISC processor instructions have consecutively entered is illustrated in FIGS. 10 through 18.

(B-1) As shown in FIG. 10, when there is no instruction being executed in the pipeline, an instruction Inst-1 enters the Stage-A from the IFU 11. A request (OK?) for determination of whether or not to operate the execution of the Inst-1 in the stage is issued to the RMU 13, and the instruction is determined to be executable (OK!) since there is no reason for disturbing execution of the Inst-1 in the stage. The Inst-1 is a CISC instruction, which does not permit simultaneous execution of other instructions in a single pipeline 12.

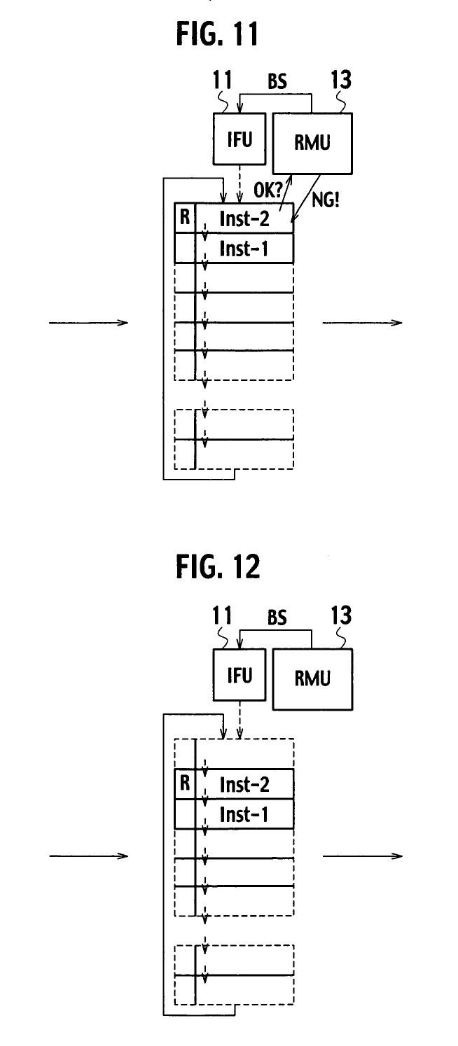

(B-2) As shown in FIG. 11, in the next clock cycle, an instruction Inst-2 enters the Stage-A from the IFU 11. A request (OK?) for determination of whether or not to operate the execution of the instruction Inst-2 is issued to the RMU 13, and due to existence of the preceding instruction Inst-1, it is determined that execution of the instruction Inst-2 is impossible (NG!). Therefore, as shown in FIG. 11, a re-execution flag R (RDF is abbreviated as R) is set to indicate that re-execution is necessary in the Stage-A. The RMU 13 simultaneously outputs a busy signal BS requesting the IFU 11 to stop instructions from entering the pipeline 12, and operates the instruction selector 15 so as to change over entry of an instruction into the Stage-A of the pipeline 12 to entry of an instruction to the final Stage-Z. At this time, the RMU operates in the same manner when the instruction Inst-2 is a RISC or a CISC instruction. The following operation is described with the instruction Inst-2 assumed to be a CISC instruction in the example given in FIG. 11.

(B-3) As shown in FIG. 12, in the next clock cycle, the IFU 11 receives a busy signal BS from the RMU 13 as a request to stop entry of instructions, and then stops operating. The pipeline 12 proceeds one stage at a time in sync with each clock cycle. The instruction Inst-1 is executed normally, but the instruction Inst-2 includes the re-execution flag R and is thus not executed.

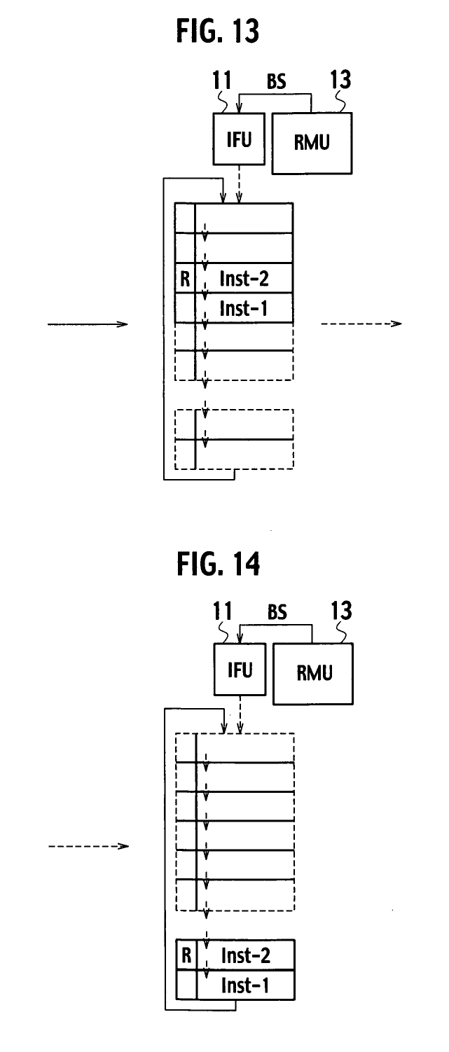

(B-4) As shown in FIG. 13, in the next clock cycle, the IFU 11 receives the busy signal BS from the RMU 13 as a request to stop entry of instructions, and then stops operating. The pipeline 12 proceeds one stage at a time in sync with each clock cycle. The instruction Inst-1 is executed normally, but the instruction Inst-2 includes the re-execution flag R and is thus not executed.

(B-5) As shown in FIG. 14, in the N-th clock cycle, the instruction Inst-1 reaches the final Stage-Z. Execution of the instruction Inst-1 is then concluded.

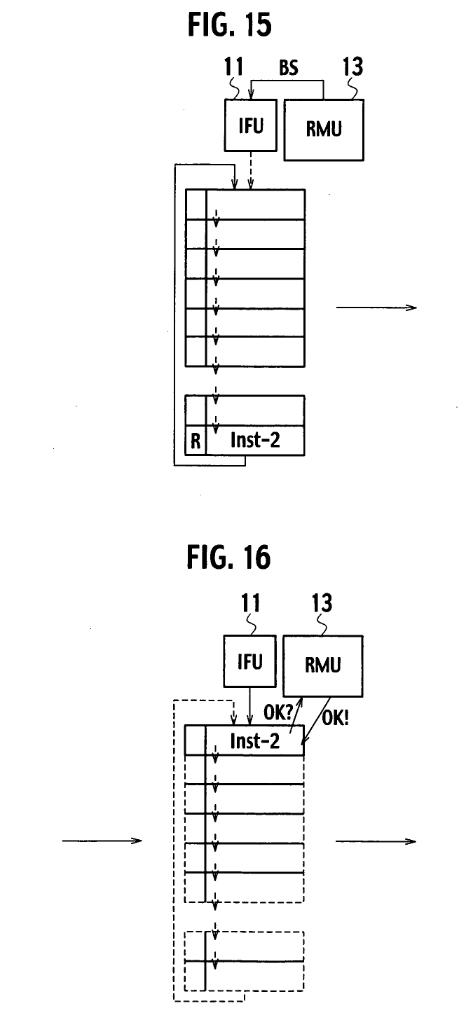

(B-6) As shown in FIG. 15, in the next clock cycle, the instruction Inst-2 with the re-execution flag R reaches the final Stage-Z.

(B-7) As shown in FIG. 16, in the next clock cycle, the instruction Inst-2 re-enters the Stage-A via the re-entry path 124. At the same time, the re-execution flag R is removed. A request (OK?) for determination of whether or not to operate the execution of the instruction Inst-2 in the stage is issued to the RMU 13, and then the instruction Inst-2 is determined to be executable (OK!) since there is no reason for disturbing execution of the instruction Inst-2 in the stage. The instruction Inst-2 is a CISC instruction, which does not permit simultaneous execution of other instructions in the single pipeline 12. Since there is no instruction with a re-execution flag R in the pipeline 12, the RMU 13 commands the instruction selector 15 changes over to an instruction from the IFU 11 and removes the busy signal BS that requested the IFU 11 to stop entry of instructions.

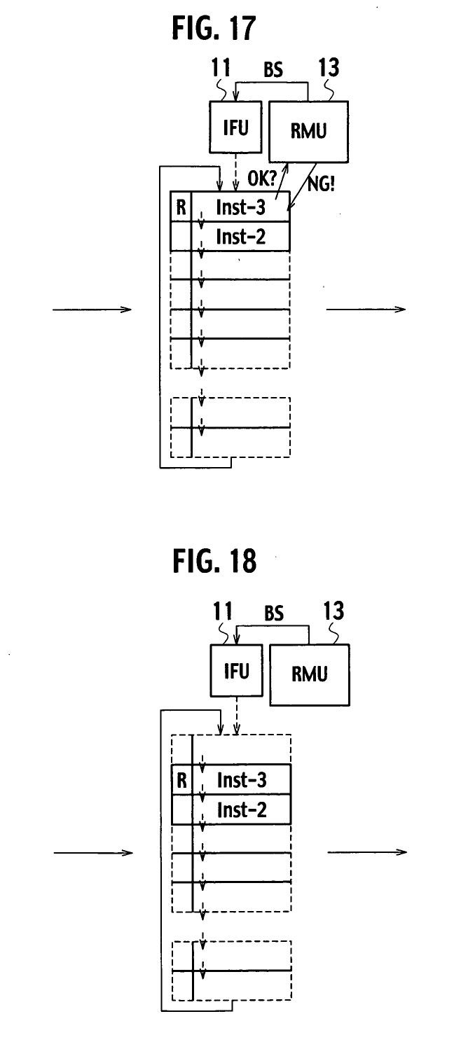

(B-8) As shown in FIG. 17, in the next clock cycle, an instruction Inst-3 enters the Stage-A. A request (OK?) for determination of whether or not to operate the execution of the instruction Inst-3 is issued to the RMU 13, and, due to the existence of the preceding instruction Inst-2, it is determined that execution of the instruction Inst-3 is impossible (NG!). Therefore, a re-execution flag R is set to indicate that re-execution is necessary in the Stage-A. The RMU 13 simultaneously outputs the busy signal BS to request the IFU 11 to stop instructions from entering the pipeline 12, and operates the instruction selector 15 so as to change over entry of an instruction into the Stage-A of the pipeline 12 to entry of an instruction from the final Stage-Z. At this time, the RMU operates in the same manner for the instruction Inst-3 regardless of whether it is a RISC or a CISC instruction. In the example given in FIG. 17, the instruction Inst-3 is a CISC instruction.

(B-9) As shown in FIG. 18, in the next clock cycle, the IFU 11 receives the busy signal BS from the RMU 13 as a request to stop entry of instructions, and then stops operating. The pipeline 12 proceeds one stage at a time in sync with each clock cycle. The instruction Inst-2 is executed normally, but the instruction Inst-3 with the set re-execution flag R is not executed.

According to the microprocessor of the first embodiment of the present invention, the addition of a small circuit to the RISC processor allows implementation of instructions that cannot be affected by the structure of pipeline stages in the RISC processor. This structure increases the scale of microprocessor instructions, improves instruction executing efficiency, and reduces power consumption and costs of the microprocessor.

The microprocessor according to the first embodiment of the present invention easily implements CISC processor instructions in the RISC processor.

[Second Embodiment]

A microprocessor according to the second embodiment of the present invention provides for high-speed pipeline processing of a RISC processor.

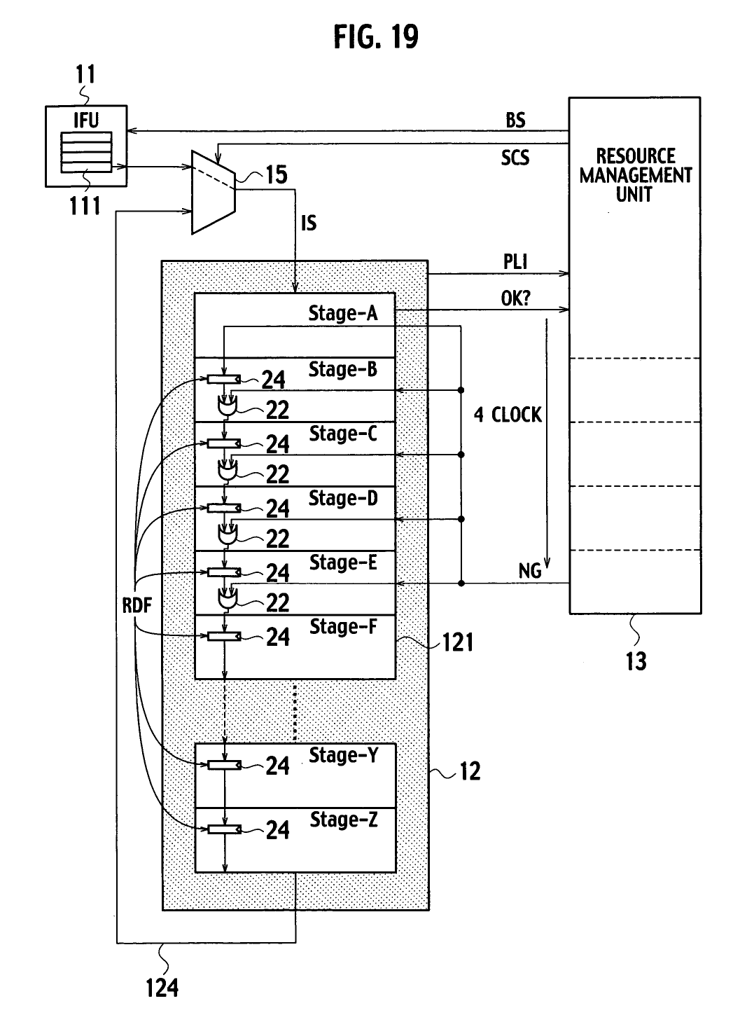

As shown in FIG. 19, a processing unit 1 of the microprocessor includes: a pipeline 12 including multiple stages; a resource management unit (RMU) 13 connected to the pipeline 12 to manage circuit resources for processing; an instruction fetch unit (IFU) 11, which sends processing commands to the pipeline 12, receives a busy signal BS from the resource management unit 13 as a request to stop commands from entering the pipeline 12, and stops commands from entering the pipeline 12; a clock generator 14 (omitted in the drawing), which is connected to the instruction fetch unit 11 and the pipeline 12, so as to regulate operation timing; and an instruction selector 15, which receives a processing command from the instruction fetch unit 11 and a command for re-entering the pipeline, via a re-entry path 124 extending from a final Stage-Z of the pipeline 12 to an initial Stage-A, and selects an instruction to enter the pipeline 12 in conformity with a control signal SCS from the resource management unit 13.

Alternatively, each of the multiple stages includes a pipeline register 24 storing a re-execution flag RDF. Also, the resource management unit 13 has a structure for returning results of requests for determination of whether or not an instruction is executable, in a stage several cycles later than the first Stage-A. Such requests are received from the first Stage-A of the pipeline 12. The resource management unit 13 then store the re-execution flags RDF in the pipeline registers 24 for all stages upstream from a stage in which a request was made to determine whether or not an instruction is executable.

The instruction fetch unit 11 retains, in instruction memory 111, an entered sequence of instructions to enter the processing unit 1, and then commands the instructions to enter the pipeline 12 in synch with clock cycles.

The resource management unit 13 receives a pipeline information signal PLI from the pipeline 12 and then manages operational statuses of respective stages of the pipeline 12 and processing of instructions. Furthermore, the resource management unit 13 determines, from current stage statuses of the pipeline 12, whether the instruction that has entered the pipeline 12 is executable, and then returns a resulting invalidating signal NG to the pipeline 12 several cycles later. Moreover, if the instruction is not executable, the resource management unit 13 requests the instruction fetch unit 11 to stop instructions from entering the pipeline, by transmitting the busy signal BS.

The pipeline 12 is divided into stages 121: Stage-A, Stage-B, . . . , and Stage-Z for processing entered instructions. The stage-divided pipeline 12 performs processing in a bucket brigade manner in sync with the clock generator 14 connected thereto. In other words, an instruction that has entered the first Stage-A from the instruction fetch unit 11 progresses to the Stage-B in sync with the subsequent clock cycle, and then to a Stage-C in sync with a further subsequent clock cycle.

An instruction entry path, along which instruction signals IS are issued from the instruction selector 15, is provided in the first Stage-A. Furthermore, the pipeline 12 generally concludes processing at the final Stage-Z; however, for the case where the processing is not completed at the Stage-Z, the pipeline 12 instructions re-enter the first Stage-A along the re-entry path 124.

The instruction selector 15 selects either one of an instruction from the instruction fetch unit 11 or an instruction from the final Stage-Z in conformity with a control signal from the resource management unit 13, and then commands the selected instruction enter the first Stage-A of the pipeline 12.

With the microprocessor according to the second embodiment of the present invention, processing in the pipeline 12 is divided into stages 121 from the Stage-A to the Stage-Z, which is the same as the first embodiment.

With the microprocessor according to the second embodiment of the present invention, as shown in FIG. 19, each of the stages Stage-B to the Stage-Z includes a pipeline register 24 that stores a re-execution flag RDF, and an OR gate 22.

The pipeline register 24 in the Stage-B receives an invalidation signal NG from the resource management unit 13. The output of the pipeline register 24 in the Stage-B is transferred to the OR gate 22 in the Stage-B. The invalidation signal NG from the resource management unit 13 is simultaneously transferred to the OR gate 22 in the Stage-B. The output of the OR gate 22 in the Stage-B is transferred to the pipeline register 24 in the Stage-C.

The output of the pipeline register 24 in the Stage-C is transferred to the OR gate 22 in the Stage-C. The invalidating signal NG from the resource management unit 13 is simultaneously transferred to the OR gate 22 in the Stage-C. The output of the OR gate 22 in the Stage-C is transferred to the pipeline register 24 in the Stage-D.

The output of the pipeline register 24 in the Stage-D is transferred to the OR gate 22 in the Stage-D. The invalidation signal NG from the resource management unit 13 is simultaneously transferred to the OR gate 22 in the Stage-D. The output of the OR gate 22 in the Stage-D is transferred to the pipeline register 24 in the Stage-E.

The output of the pipeline register 24 in the Stage-E is transferred to the OR gate 22 in the Stage-E. The invalidation signal NG from the resource management unit 13 is simultaneously transferred to the OR gate 22 in the Stage-E.

The second embodiment is different from the first embodiment in that results of a request in the first Stage-A to the management unit 13 for determining whether or not an instruction is executable are returned in the Stage-E four cycles later. In this case, four succeeding instructions enter the pipeline 12 until the results of determining whether or not an instruction is executable are output from the resource management unit 13. The resource management unit 13 sets re-execution flags R for all stages upstream from a stage in which the request for determining whether or not an instruction is executable is made. Note that in the same way as the case of the first instruction of the succeeding four instructions, in which a request for determining whether or not the instruction is executable, a request for determining whether or not an instruction is executable is issued when the instruction is in the Stage-A. These instructions are all invalid because the re-execution flags R are-set at the same time. Accordingly, the resource management unit 13 invalidates the requests issued for these instructions for determining whether or not the instructions are executable.

Note that the case where the results of requesting the resource management unit 13 to determine whether or not an instruction is executable in the Stage-A is returned in Stage-E four cycles later, the results may naturally be returned after any number of multiple cycles, and is not limited to four. Even the fact that the resource management unit 13 sets re-execution flags R for all stages up stream from a stage in which a request for determining whether or not the instruction is executable is the same as the aforementioned case.

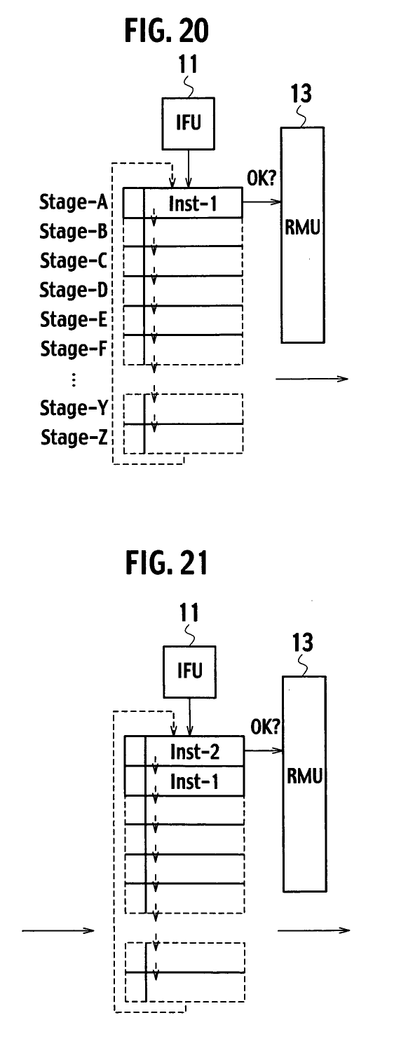

(C) FIGS. 20 through 30 show processing progression through pipeline stages when RISC processor instructions have entered the pipeline 12.

(C-1) As shown in FIG. 20, when there is no instruction being executed in the pipeline, an instruction Inst-1 enters the Stage-A from the IFU 11. The instruction Inst-1 requests the RMU 13 to determine whether or not the instruction is executable. Determination results are not returned in this stage.

(C-2) As shown in FIG. 21, in the next clock cycle, an instruction Inst-2 enters the Stage-A from the instruction fetch unit. The Inst-2 requests the RMU 13 to determine whether or not the instruction is executable. Determination results are not returned in this stage.

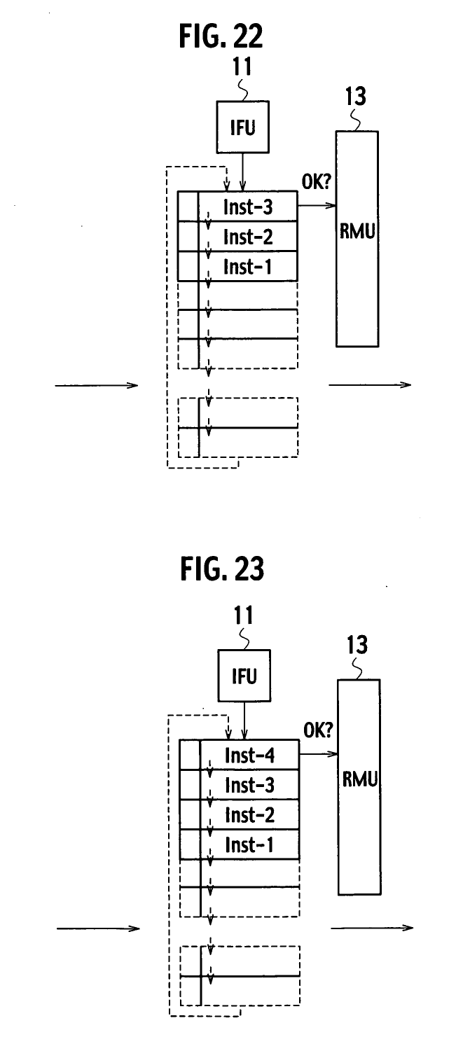

(C-3) As shown in FIG. 22, in the next clock cycle, an instruction Inst-3 enters the Stage-A from the IFU 11. The instruction Inst-3 requests RMU 13 to determine whether or not the instruction is executable. Determination results are not returned in this stage.

(C-4) As shown in FIG. 23, in the nextclock cycle, an instruction Inst-4 enters the Stage-A from the IFU 11. The instruction Inst-4 requests the RMU 13 to determine whether or not the instruction is executable. Determination results are not returned in this stage.

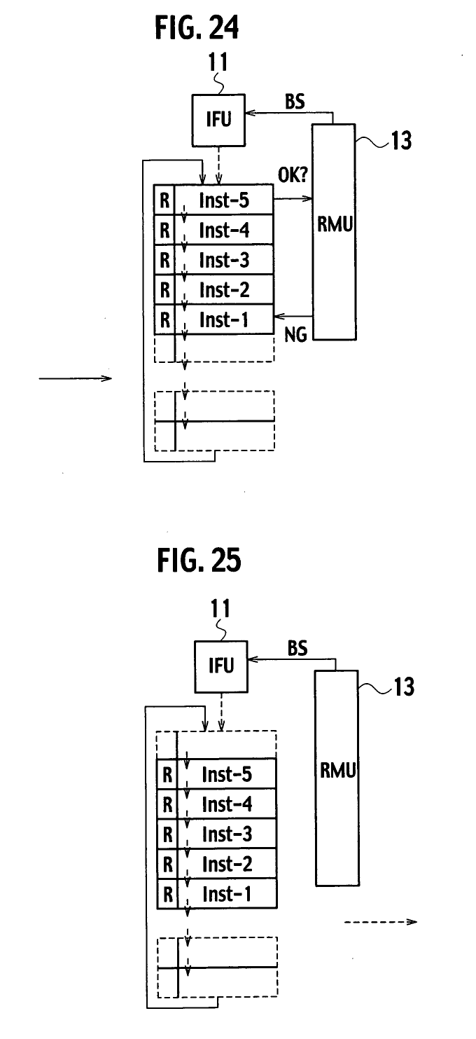

(C-5) As shown in FIG. 24, in the next clock cycle, the determination of whether or not the instruction Inst-1 is executable is output after four clock cycles. The instruction Inst-1 receives the determination results in the Stage-E. In this example, since the determination is, for some reason, that the instruction Inst-1 is non-executable, a re-execution flag R to request re-execution in a stage upstream from a stage that the instruction Inst-1 has entered is issued. At this time, the RMU 13 outputs a request to the IFU 11 to stop instructions from entering the pipeline, and switches over the instruction selector 15 so as to change over to command an instruction from the final Stage-Z of the pipeline 12 to enter the Stage-A.

(C-6) As shown in FIG. 25, while in the next cycle, the Stage-E is a stage in which the determination of whether or not the instruction Inst-2 is executable is issued, an additional re-execute request is not issued from the RMU 13 since there is a re-execution flag R indicating a re-execute request.

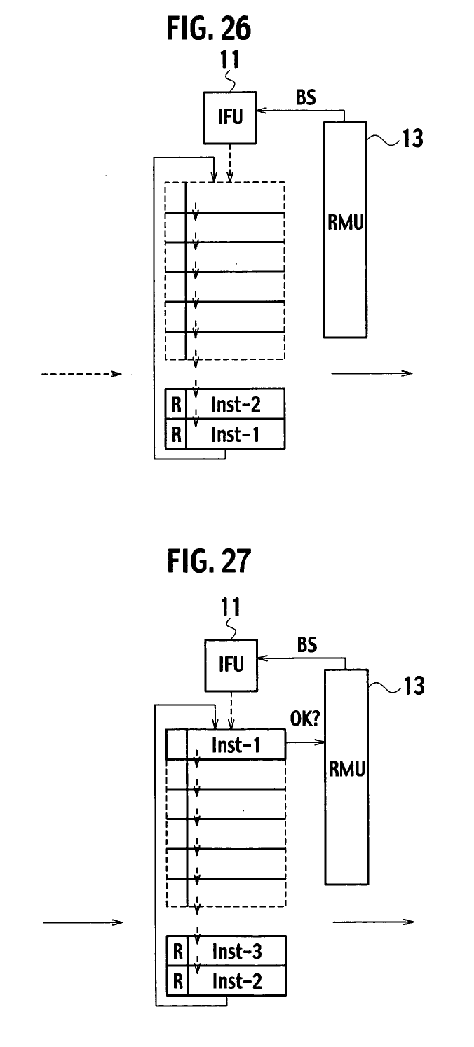

(C-7) As shown in FIG. 26, in the N-th clock cycle, the instruction Inst-1 reaches the final Stage-Z of the pipeline 12.

(C-8) As shown in FIG. 27, in the next clock cycle, the instruction Inst-1 enters the first Stage-A of the pipeline 12, and the re-execution flag R is reset at the same time. The instruction Inst-1 requests the RMU 13 to determine whether or not the instruction is executable. Determination results are not returned in this Stage-A.

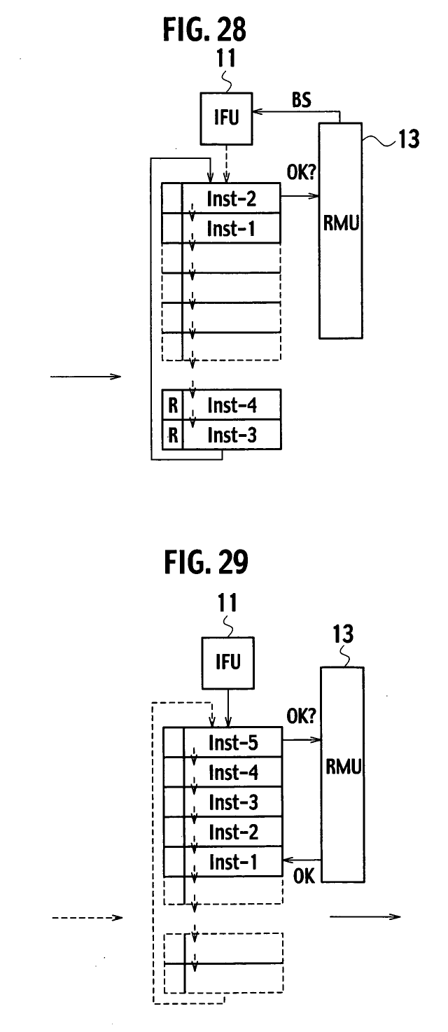

(C-9) As shown in FIG. 28, in the next clock cycle, the instruction Inst-2 enters the first Stage-A of the pipeline 12, and the re-execution flag R is reset at the same time. The instruction Inst-2 requests the RMU 13 to determine whether or not the instruction is executable. Determination results are not returned in this Stage-A.

(C-10) As shown in FIG. 29, in the next clock cycle, an instruction Inst-5 enters the first Stage-A of the pipeline 12, and the re-execution flag R is reset at the same time. Since there is no longer an instruction having a re-execution flag R in the pipeline 12, the RMU 13 controls the instruction selector 15 to switch over to entering instructions from the IFU 11 and removes the busy signal BS that requests the stop entry of instructions into the IFU 11. The instruction Inst-5 requests the RMU 13 to determine whether or not the instruction is executable. As a result, the results of determining whether or not the instruction Inst-1 is executable are output from the RMU 13 in the Stage-E. This time, the instruction is determined to be executable (OK).

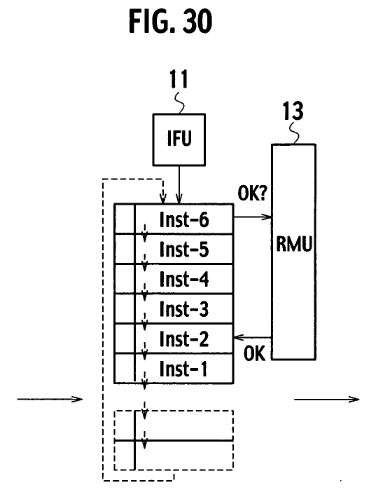

(C-11) As shown in FIG. 30, in the next clock cycle, an instruction Inst-6 is issued from the IFU 11, and a request for determining whether the instruction is executable or not is issued to the RMU 13. Results of the determination of whether the instruction Inst-2 is executable or not are output from the RMU 13 in the Stage-E. This time, the instruction is determined to be executable (OK).

According to the microprocessor of the second embodiment of the present invention, the re-execution flags and instruction re-enter function permit reception, in a downstream stage during execution of an instruction, of results of determining in upper-stream stages of the pipeline whether or not each instruction is executable, instead of in the same upper-stream stages. This procedure prevents a decrease in the processing speed of the microprocessor, even if a complicated determination is made of whether or not each instruction is executable.

[Other Embodiments]

While the present invention has been described according to the first through the second embodiment, these embodiments and drawings constituting a part of this disclosure do not limit the scope of the present invention. This disclosure shows those skilled in the present invention a variety of embodiments, alternative embodiments, and operational technologies.

Needless to say, the present invention includes a variety of embodiments or the like not disclosed herein. Therefore, the technical scope of the present invention should be defined by only inventive descriptions according to the claimed invention, which is appropriate according to the aforementioned descriptions.

While the present invention is described in accordance with the aforementioned embodiments, it should not be understood that the description and drawings that configure part of this disclosure are to limit the present invention. This disclosure makes clear a variety of alternative embodiments, working examples, and operational techniques for those skilled in the art. Accordingly, the technical scope of the present invention is defined by only the claims that appear appropriate from the above explanation. Various modifications will become possible for those skilled in the art after receiving the teachings of the present disclosure without departing from the scope thereof.

What is claimed is:

1. A microprocessor comprising:
a pipeline including a plurality of stages;
a resource management unit configured to be connected to the pipeline and manage circuit resources for processing instructions in the pipeline;
an instruction fetch unit configured to issue processing commands to the pipeline, receive a busy signal from the resource management unit requesting the instruction fetch unit to stop issuing commands to the pipeline, and stops issuing commands to the pipeline in response to the busy signal; and
an instruction selector configured to receive the processing commands from the instruction fetch unit and a command from a final stage of the pipeline that will re-enter the pipeline via a re-entry path extending to a first stage of the pipeline, and select an instruction to enter the pipeline in conformity with a control signal from the resource management unit.

2. The microprocessor of claim 1, wherein the pipeline includes a stage management queue for managing progression of processing through stages for entered instructions.

3. The microprocessor of claim 1, wherein the instruction selector receives, via the re-entry path, an instruction code in the final stage of the pipeline, which will either need to be executed or not executed, and then command that instruction code to enter the first stage of the pipeline.

4. The microprocessor of claim 1 further comprising:
a clock generator configured to send a clock signal to the pipeline and the instruction fetch unit.

5. The microprocessor of claim 1, wherein the resource management unit receives a pipeline information signal from the pipeline, manages operational statuses of respective stages of the pipeline and processing of instructions, sends execution determination results to the pipeline from current stage statuses of the pipeline as to whether the instruction that has entered the pipeline is executable, and then transmits the busy signal to request the instruction fetch unit to stop an instruction from entering the pipeline.

6. The microprocessor of claim 2, wherein the stage management queue includes an instruction retaining unit, which retains an instruction code in each stage that either requires or does not require re-execution of processing for the code, and a stage controller storing re-execution flags.

7. The microprocessor of claim 6, wherein the pipeline executes CISC processor instructions by operation of the entire pipeline.

8. The microprocessor of claim 6, wherein the pipeline executes RISC processor instructions that provides a divided stage structure in a processing pipeline in which the divided stages are independent from one another.

9. The microprocessor of claim 4, wherein the instruction fetch unit includes an instruction memory that stores an instruction sequence for entering instructions in the pipeline, and enters an instruction in the pipeline in sync with the clock signal.

10. A microprocessor comprising:
a pipeline including a plurality of stages;
a resource management unit configured to be connected to the pipeline and manage circuit resources for processing instructions in the pipeline;
an instruction fetch unit configured to issue processing commands to the pipeline, receive a busy signal from the resource management unit requesting the instruction fetch unit to stop issuing commands to the pipeline, and stops issuing commands to the pipeline in response to the busy signal; and
an instruction selector configured to receive a processing commands from the instruction fetch unit and a command from a final stage of the pipeline that will re-enter the pipeline via a re-entry path extending to a first stage of the pipeline, and select an instruction to enter the pipeline in conformity with a control signal from the resource management unit; wherein
the plurality of stages include respective pipeline registers storing re-execution flags, and
the resource management unit returns results of request for determining whether or not an instruction is executable received from a first stage in a stage several cycles later, and stores the re-execution flags in the respective pipeline registers for all stages upstream from a stage in which an instruction has requested a determination whether or not the instruction is executable.

11. The microprocessor of claim 10, wherein the plurality of stages further include respective OR gates having an input terminals connected to the pipeline storage register and another input terminals connected to the resource management unit.

12. The microprocessor of claim 10, wherein the instruction selector receives, via the re-entry path, an instruction code in a final stage of the pipeline, which will either need or not need to be executed, and then commands the instruction code to enter the first stage of the pipeline.

13. The microprocessor of claim 10, wherein the pipeline executes RISC processor instructions that permit a divided stage structure in a processing pipeline, the divided stages being independent from one another.

14. The microprocessor of claim 10 further comprising:
a clock generator configured to send clock signals to the pipeline and the instruction fetch unit.

15. The microprocessor of claim 10, wherein the resource management unit receives a pipeline information signal from the pipeline, manages operational statuses of respective stages of the pipeline and processing of instructions, sends execution determination results as an invalidating signal results to the pipeline from current stage statuses of the pipeline as to whether the instruction that has entered the pipeline is executable in a stage several cycles later, and then transmits the busy signal to request the instruction fetch unit to stop an instruction from entering the pipeline.

16. The microprocessor of claim 11, wherein the OR gates connected to the pipeline registers for all stages upstream from a stage in which a request is made to determine whether or not an instruction is executable receive an invalidation signal from the resource management unit.

17. The microprocessor of claim 12, wherein the instruction fetch unit includes an instruction memory that stores an instruction sequence for entering instructions in the pipeline, and enters an instruction in the pipeline in sync with the clock signal.
